(19) United States
(12) Patent Application Publication
(10) Pub. No.: US 2007/0109261 A1
(43) Pub. Date: May 17, 2007

(54) INFORMATION PROCESSING METHOD AND INFORMATION PROCESSING APPARATUS

(75) Inventors: Hiromi Omi, Tokyo (JP); Masayuki Yamada, Tokyo (JP); Toshiaki Fukada, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/552,340

(22) Filed: Oct. 24, 2006

(30) Foreign Application Priority Data
Nov. 11, 2005 (JP) 2005-327569

(51) Int. Cl. G09G 5/00

(52) U.S. Cl. 345/156

(57) ABSTRACT

On a display screen of an information processing apparatus, input unit information (an image or a color) which represents an input unit used to move a focus to an item capable of being focused on is displayed along with the item capable of being focused on so as to enhance the usability of the information processing apparatus for users.

### BACKGROUND OF THE INVENTION

1. Field of the Invention

The present invention relates to an operational support technique for an information processing apparatus that displays information on its display screen.

2. Description of the Related Art

Remote controllers are often used for operating the display screens of televisions, projectors, or the like, and the arrow (up, down, left, and right) keys or stick devices of the remote controllers are often used for moving the focus (e.g., selection cursor or pointer) on the display screens.

However, the direction selected with an input device of a remote controller (for example, the right direction selected with a right key) does not always match any possible focus moving direction on a display screen, since there are many types of display screen layouts. Accordingly, it is difficult for a user to know which key the user should press so as to move the focus toward a desired direction.

As a method of supporting display screen operations, for example, Japanese Laid-Open No. 2002-149144 discloses a method of displaying items to which the focus can be moved from an item using images of arrows. In addition, Japanese Laid-Open No. 2002-305696 discloses a method of highlighting the directions in which a cursor can be moved and displaying the cursor moving directions using images of arrows, each of which corresponds to any one of up, down, left and right keys, by performing a predetermined operation.

The technique disclosed in Japanese Laid-Open No. 2002-149144 or 2002-305696 allows a user to intuitively know items to which the focus can be moved or the directions in which the focus can be moved from a currently focused-on location. However, if the direction selected with an input device of a remote controller does not match any possible focus moving direction on a display screen, it is difficult for a user to know which key the user should press so as to move the focus toward a desired direction. For example, even if a user presses an up key, the focus may move from a currently focused-on item toward the nearest item located in the upper right or left of the currently focused-on item, because there is no item directly above the currently focused-on item. In such a case, the user cannot intuitively know where the focus will move.

### SUMMARY OF THE INVENTION

Embodiments of the present invention provide an information processing method and an information processing apparatus capable of providing enhanced usability to users by displaying input unit information (the image or color of a key), which is used to move a focus (e.g., selection cursor or pointer) on a display screen to an item capable of being focused on (selected), along with the item capable of being focused on.

According to an aspect of the present invention, there is provided a method that includes the following: selecting one of a plurality of items displayed on a display screen based on information received via an input section that has a plurality of operable input units; acquiring information on a correspondence between the selected item and one of the displayed items capable of being selected using one of the operable input units; and displaying input unit information which represents the one of the operable input units along with the one of the displayed items capable of being selected using the one of the operable input units based on the acquired correspondence information.

According to another aspect of the present invention, there is provided a method that includes the following: selecting one of a plurality of items displayed on a display screen based on information received via an input section that has a plurality of input units; and displaying input unit information that represents one of the input units associated with one of the displayed items to be selected when the one of the input units is operated in a state corresponding to the selected item.

According to yet another aspect of the present invention, there is provided an apparatus that includes the following: a selection unit configured to select one of a plurality of items displayed on a display screen based on information received via an input section that has a plurality of operable input units; an acquisition unit configured to acquire information on a correspondence between the item selected by the selection unit and one of the displayed items capable of being selected using one of the operable input units; and a display control unit configured to control the display screen to display input unit information which represents the one of the operable input units along with the one of the displayed items capable of being selected using the one of the operable input units based on the correspondence information acquired by the acquisition unit.

According to still yet another aspect of the present invention, there is provided an apparatus that includes the following: a selection unit configured to select one of a plurality of items displayed on a display screen based on information received via an input section that has a plurality of input units; and a display control unit configured to control the display screen to display input unit information that represents one of the input units associated with one of the displayed items to be selected when the one of the input units is operated in a state corresponding to the item selected by the selection unit.

Further features of the present invention will become apparent from the following description of exemplary embodiments with reference to the attached drawings.

### BRIEF DESCRIPTION OF THE DRAWINGS

FIG. 1 is a block diagram showing a basic configuration of an information processing apparatus according to a first embodiment of the present invention.

FIG. 2A is a diagram showing an example of a display screen of an information processing apparatus.

FIG. 2B is a diagram showing an example of a display screen according to the first embodiment of the present invention.

FIG. 2C is a diagram showing an exemplary remote controller according to the first embodiment of the present invention.

FIG. 3 is a diagram showing an example of display screens transitioning from one state to another in response to the focus being moved from one item to another according to the first embodiment of the present invention.

FIG. 4A is a diagram showing an example of a display screen of an information processing apparatus.

FIG. 4B is a diagram showing an example of a display screen according to a second embodiment of the present invention.

FIG. 4C is a diagram showing an exemplary remote controller according to the second embodiment of the present invention.

FIG. 5 is a diagram showing an exemplary table detailing correspondences between the operation keys of the information processing apparatus according to the first embodiment and items capable of being focused on.

FIG. 6 is a diagram showing an exemplary table detailing the key information (an image file representing a key) of the information processing apparatus according to the first embodiment of the present invention.

FIG. 7 is a diagram showing an exemplary table detailing the key information (a color representing a key) of the information processing apparatus according to the second embodiment of the present invention.

FIG. 8 is a flowchart showing an operational procedure of the information processing apparatus according to the first embodiment of the present invention.

FIG. 9 is a flowchart showing an operational procedure of the information processing apparatus according to the second embodiment of the present invention.

FIGS. 10A and 10B are diagrams showing exemplary operations of the information processing apparatus according to the first embodiment of the present invention.

FIGS. 11A and 11B are diagrams showing exemplary operations of the information processing apparatus according to the second embodiment of the present invention.

### DESCRIPTION OF THE EMBODIMENTS

Exemplary embodiments of the present invention will be described with reference to the accompanying drawings.

First Embodiment

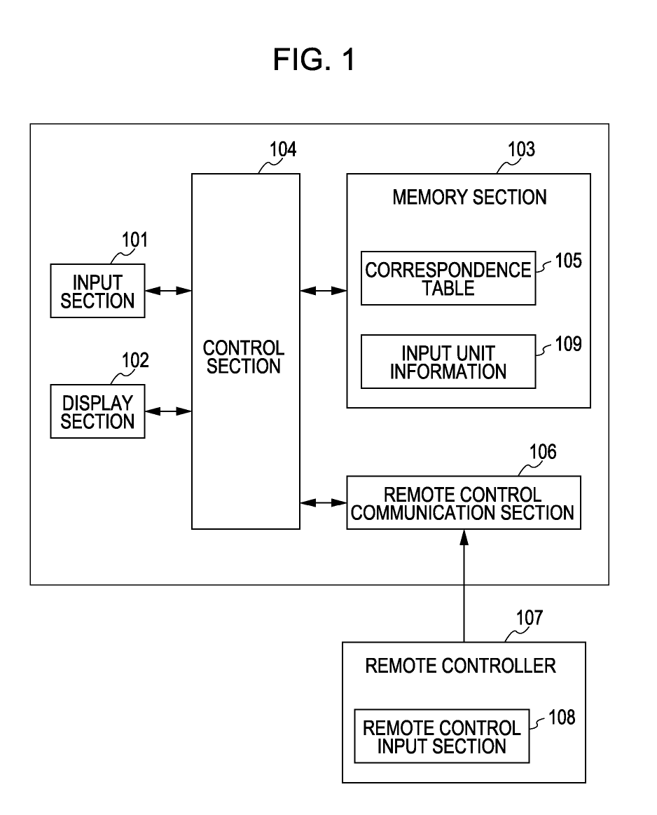

FIG. 1 is a block diagram showing a basic configuration of an information processing apparatus according to the first embodiment of the present invention. The information processing apparatus is configured with an input section 101, a display section 102, a memory section 103, a control section 104, a correspondence table 105, and a remote control communication section 106. The illustrated information processing apparatus is capable of communicating with a remote controller 107.

The input section 101 is configured with an input device such as buttons or a touch panel, and functions as an input interface for inputting various instructions into the information processing apparatus.

The display section 102 is configured with a display device such as a liquid crystal display, and displays various image information and text information. The display section 102 may be configured with a touch-panel display device, and, in that case, doubles as the input section 101 that functions as an input interface for inputting various instructions into the information processing apparatus.

The memory section 103 is configured with a hard disk drive for storing various information or a storage medium for providing various information to the information processing apparatus such as a CD-ROM or DVD-ROM. Various application programs, user interface control programs, and various types of data required for executing each program are stored in the memory section 103, and are read by the information processing apparatus under the control of the control section 104 at a subsequent stage.

The control section 104 is configured with a work memory, a CPU, or an MPU, and performs various types of processing by reading out programs or data stored in the memory section 103.

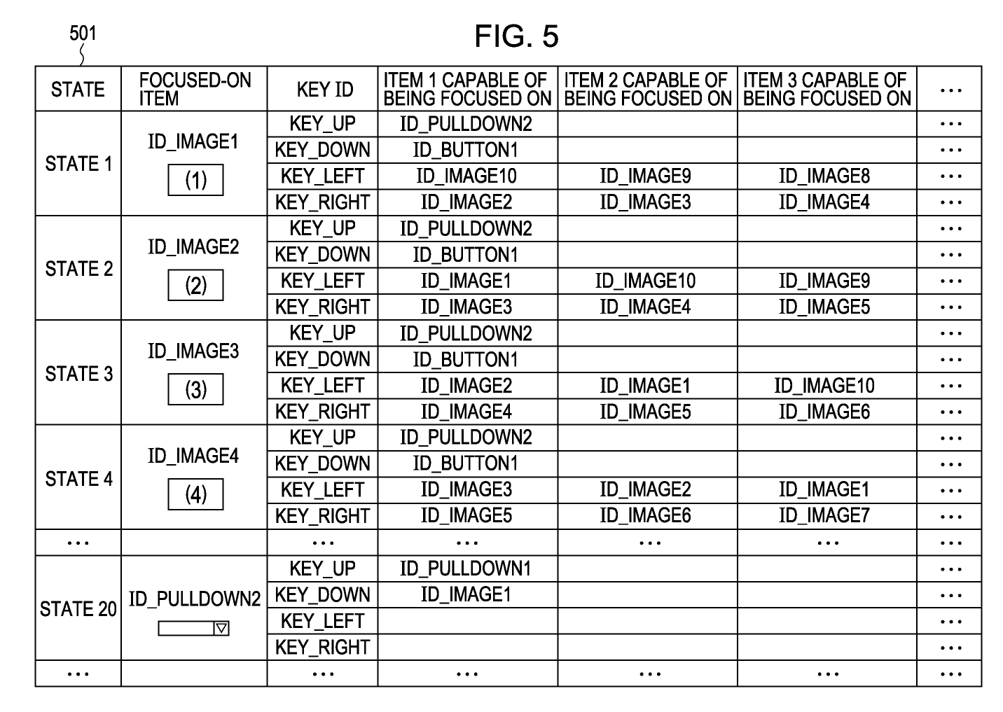

The correspondence table 105 is a table (FIG. 5) detailing correspondences between items capable of being focused on which are displayed on the display section 102 and information on a remote control input section 108. The correspondence table 105 is stored in the memory section 103. The details of the correspondence table 105 will be described later.

The remote control communication section 106 receives an infrared signal transmitted from the remote controller 107 (described later), and demodulates the received infrared signal, and then transmits a code obtained from the remote control operation to the control section 104. In this embodiment, although communication by means of an infrared signal is described by way of example, a suitable communication system such as radio frequency communication or wire communication may be employed.

The remote controller 107 receives an input signal from the remote control input section 108 (described later), and transmits an infrared signal to the remote control communication section 106 in accordance with the received input signal.

The remote control input section 108 is configured with an input device such as buttons, a joystick, a switch, or a touch wheel, and functions as a user input interface for inputting various instructions into the remote controller 107.

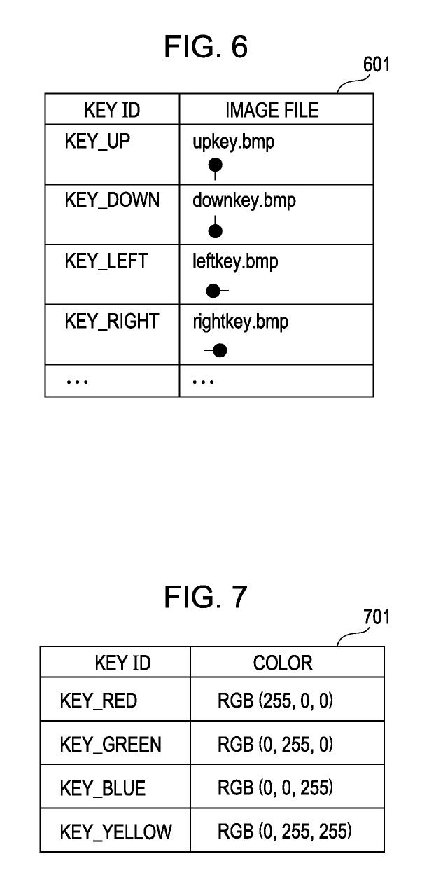

Input unit information 109 is information on the image or color of the input device of the input section 101 or the remote control input section 108 (FIGS. 6 and 7), and is stored in the memory section 103. The details of the input unit information 109 will be described later.

Next, the correspondence table 501 shown in FIG. 5 will be described. The correspondence table 501 is a table detailing correspondences between operable keys (also referred to herein as “operable input units”) and items to which the focus (e.g., selection cursor or pointer) can be moved for each state of a user interface. Here, the states of the user interface and the names of the states are defined in advance, and a unique ID is assigned to each key and item.

In the correspondence table 501, state names are shown in a “state” column, and the IDs of items that are focused (selected) in states in the “state” column are shown in a “focused-on item” column, and remote control key IDs are shown in a “key ID” column. The IDs of items capable of being focused (selected) on when keys in the “key ID” column are operated are shown in an “item 1 capable of being focused on” column. The IDs of items capable of being focused (selected) on next when keys in the “key ID” column are operated are shown in “item 2 capable of being focused on” and “item 3 capable of being focused on” columns in ascending order of the number of movements from a currently focused-on item. The IDs of a plurality of items may be shown in the single cell of the “item 2 capable of being focused on” column and the subsequent columns.

An image table 601 shown in FIG. 6 is a table detailing correspondences between the keys of the remote controller and the images of the keys, and is stored in the memory section 103. The IDs of the keys and the URIs of image files indicating the keys are shown in a “key ID” column and an “image file” column, respectively.

Similarly, a color table 701 shown in FIG. 7 is a table detailing correspondences between remote control keys and the colors of the keys, and is stored in the memory section 103. The IDs and colors of the keys are shown in a “key ID” column and a “color” column, respectively.

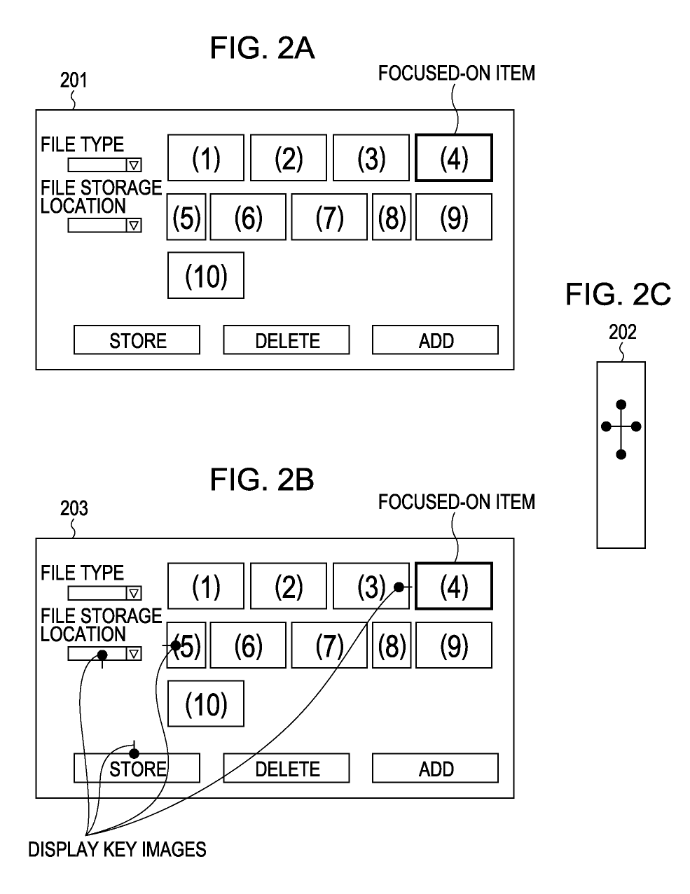

FIG. 2A is a diagram showing an example of a display screen of an information processing apparatus. FIG. 2B is a diagram showing an example of a display screen according to the first embodiment of the present invention. FIG. 2C is a diagram showing an exemplary remote controller according to the first embodiment of the present invention. A remote controller 202 shown in FIG. 2C is provided with arrow keys used to move the focus vertically or horizontally. On a display screen 201 displayed on a display which is shown in FIG. 2A, when a user wants to move the focus from a currently focused-on item to a “file storage location” item, it is difficult for the user to intuitively know which key the user should operate so as to move the focus to the item (or near the item).

Here, a screen 203 that is acquired by applying an embodiment of the present invention to the display screen 201 and displaying images representing keys on the display screen 201 is shown in FIG. 2B. On the screen 203, the images of up, down, left and right keys are individually displayed on items to which the focus will be moved if keys corresponding to the key images are pressed in the current state. An image representing the up key is displayed on the “file storage location” item, whereby a user can intuitively understand that the user should press the up key to move the focus to the “file storage location” item.

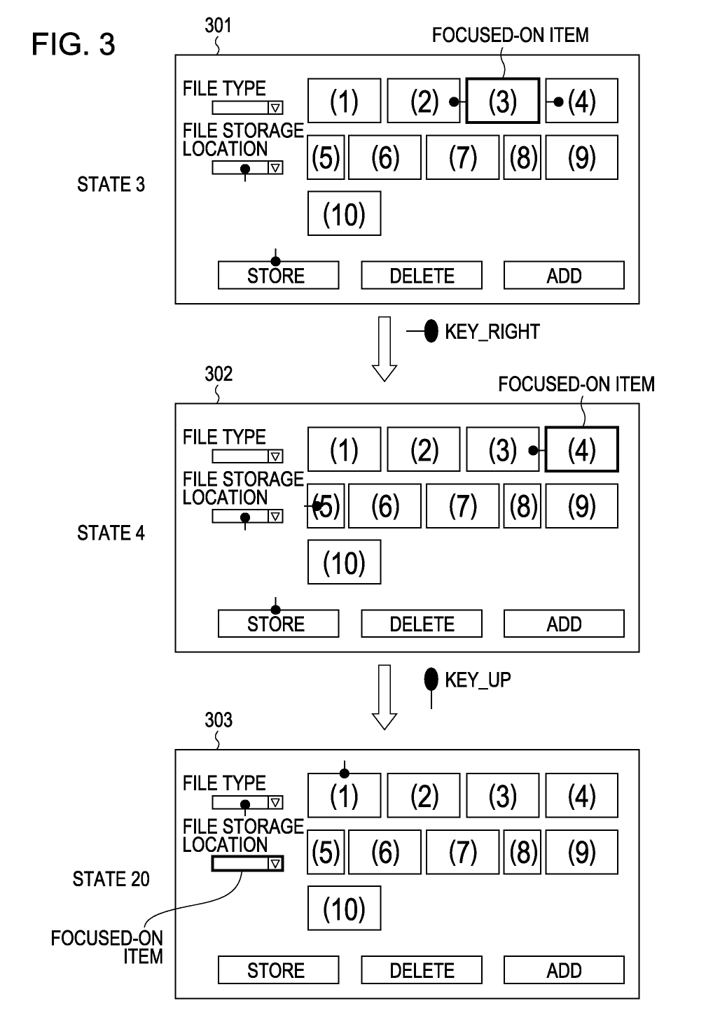

FIG. 3 is a diagram showing an example of display screens transitioning from one state to another in response to the focus being moved from one item to another according to the first embodiment of the present invention. A screen 301 is displayed in a “state 3” of the correspondence table 501 shown in FIG. 5. On the screen 301, an ID_IMAGE3 item is focused, and the images of the up, down, left, and right keys are displayed on ID_PULLDOWN2, ID_BUTTON1, ID_IMAGE2, and ID_IMAGE4 items, respectively.

If the right key is pressed in the “state 3”, a transition from the “state 3” to a “state 4” of the correspondence table 501 occurs. Consequently, on a screen 302, the ID_IMAGE4 item is focused, and the key images are similarly displayed on corresponding items.

If the up key is pressed in the “state 4”, a transition from the “state 4” to a “state 20” of the correspondence table 501 occurs. Consequently, on a screen 303, the ID_PULLDOWN2 item is focused, and the key images are similarly displayed on corresponding items.

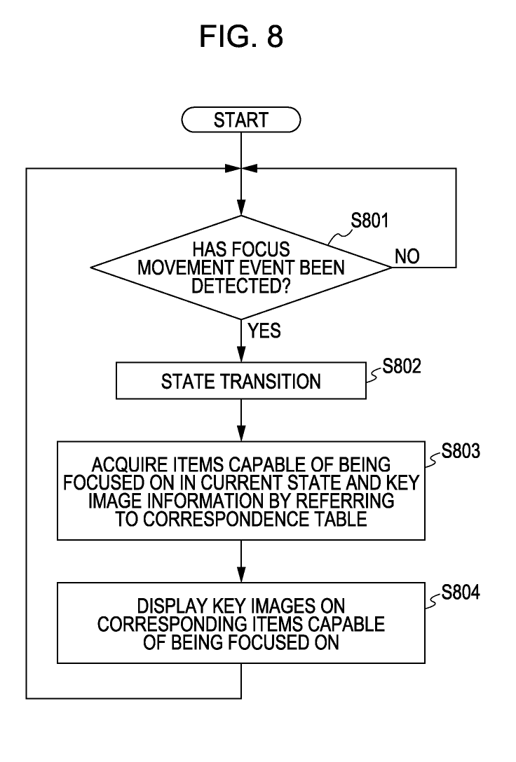

Next, an operational procedure of the information processing apparatus according to the first embodiment of the present invention will be described with reference to the flowchart of FIG. 8. A program for executing the operational procedure of the flowchart is stored in the memory section 103 and is executed under the control of the control section 104.

When a focus movement event has been detected (YES in step S801), the state transition of a user interface occurs by the focus movement (step S802). After the state transition of the user interface, by referring to the correspondence table 501 (FIG. 5), items to which the focus can be moved in the current state (shown in the “item 1 capable of being focused on” column) are acquired, and by referring to the image table 601 (FIG. 6), image information on each key is acquired (step S803). Subsequently, key images are individually displayed on corresponding items to which the focus can be moved on the screen (step S804). The display of the key images is performed using a suitable image processing technique. It is possible to prevent an item from being hidden by the corresponding key image by increasing the transparency of the corresponding key image.

The above-described items to which the focus can be moved are not limited to items shown in the “item 1 capable of being focused on” column, and given items shown in the “item 2 capable of being focused on” or “item 3 capable of being focused on” column, or another column may be acquired and displayed. If all items are acquired, key images are displayed on all items to which the focus can be moved as shown on a screen 1001 in FIG. 1A. In this case, a user can operate a key corresponding to a key image displayed on an item to which the user wants to move the focus.

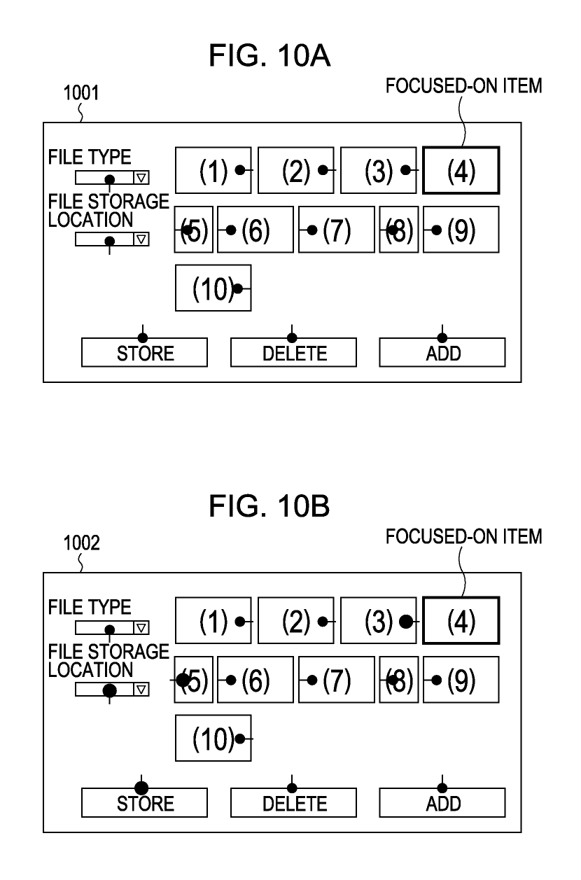

Furthermore, as shown in a screen 1002 in FIG. 10B, it is possible to explicitly indicate the difference between an item to be focused on after a key operation is performed and an item near the item to be focused on by making the size of key images displayed on the items shown in the “item 1 capable of being focused on” column different from the size of key images displayed on the items shown in the “item 2 capable of being focused on” column and subsequent columns. In this case, the size difference may be displayed by enlarging or reducing the same key image or by using image files of different sizes. The size of a key image may be gradually varied for the items shown in the “item 2 capable of being focused on” column and subsequent columns.

Thus, according to the first embodiment of the present invention, key images for a focus movement are individually displayed on items. This enables a user to intuitively understand which key the user should operate so as to move the focus to a desired item, thereby enhancing the usability of the information processing apparatus.

Second Embodiment

Next, the second embodiment of the present invention will be described. In the first embodiment, remote control key images are individually displayed on items. In the second embodiment, remote control key colors are displayed.

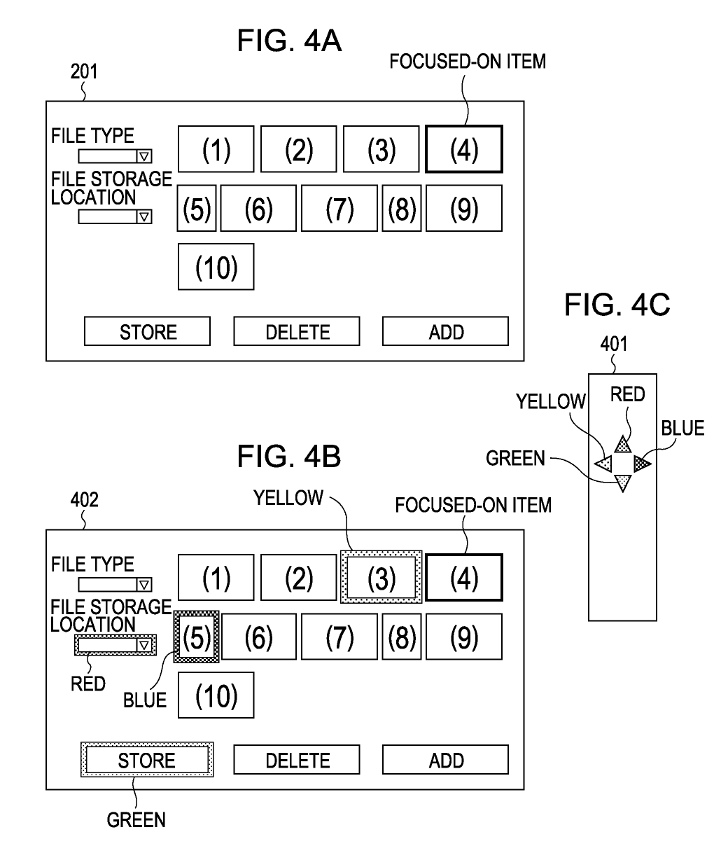

FIG. 4A is a diagram showing an example of a display screen of an information processing apparatus. FIG. 4B is a diagram showing an example of a display screen according to the second embodiment of the present invention. FIG. 4C is a diagram showing an exemplary remote controller according to the second embodiment of the present invention. The remote controller 401 shown in FIG. 4C is provided with arrow keys used to move the focus vertically or horizontally. The up, down, left and right keys of the arrow keys have different colors.

As described in the first embodiment, it is difficult for a user to intuitively perform a key operation on the display screen 201 shown in FIG. 4A. Accordingly, a screen 402 is shown in FIG. 4B which is acquired by applying an embodiment of the present invention to the display screen 201 and displaying boxes having the colors of keys (acquired by referring to the color table 701 shown in FIG. 7) around corresponding items to which the focus will be moved if the keys are pressed. A red box is displayed around the “file storage location” item, whereby a user can intuitively understand that the user should press a red key so as to move the focus to the “file storage location” item. On the screen 402, boxes having key colors are individually displayed around corresponding items, but the items themselves may be displayed with the key colors.

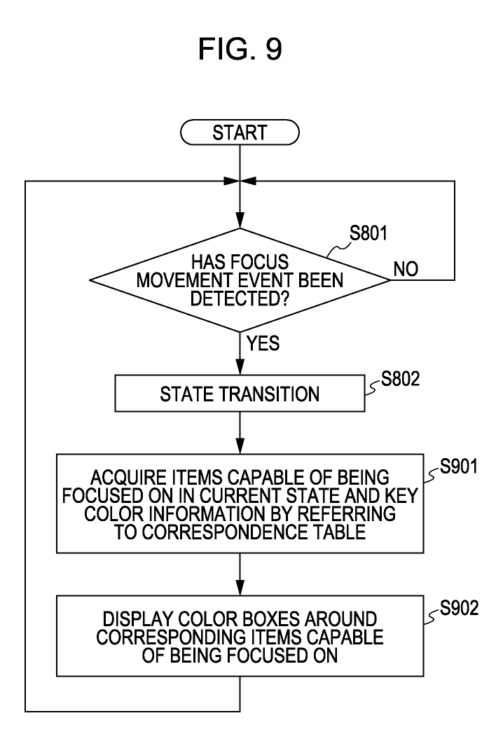

The operational procedure of the information processing apparatus according to the second embodiment of the present invention will be described with reference to the flowchart of FIG. 9. A program for executing the operational procedure of the flowchart is stored in the memory section 103 and is executed under the control of the control section 104.

Here, only steps 901 and 902 will be described, since the steps 801 and 802 have been described in the first embodiment with reference to FIG. 8.

After the state transition of step S802, in step S901, by referring to the correspondence table 501 (FIG. 5), items to which the focus can be moved in the current state (shown in the “item 1 capable of being focused on” column) are acquired, and by referring to the color table 701 (FIG. 7), color information on each key is acquired. Subsequently, color boxes are displayed around corresponding items to which the focus can be moved on the screen (step S902). The display of the color boxes is performed using known techniques. For example, in the case of HTML, border thickness, color, and style can be varied by specifying a border type using a style sheet. This technique is commonly used.

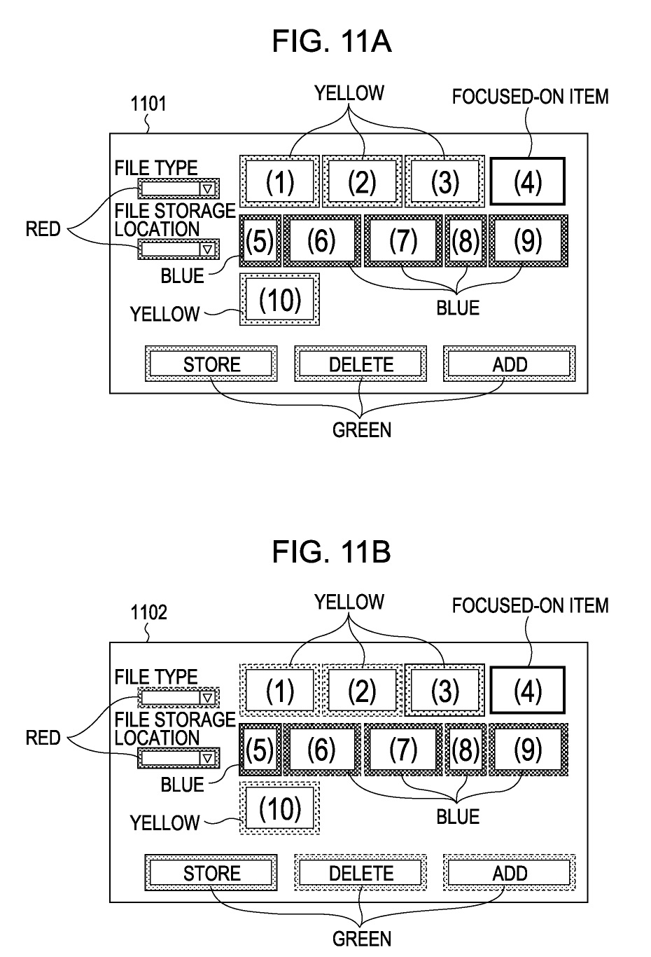

Like the first embodiment, the above-described items to which the focus can be moved are not limited to items shown in the “item 1 capable of being focused on” column, and given items shown in the “item 2 capable of being focused on” or “item 3 capable of being focused on” column, or another column may be acquired and displayed. If all items are acquired, color boxes corresponding to the colors of the arrow keys are displayed around all items to which the focus can be moved as shown in a screen 1101 in FIG. 11A. In this case, a user can operate a key having the color of a box displayed around an item to which the user wants to move the focus.

Furthermore, as shown in a screen 1102 in FIG. 11B, it is possible to explicitly indicate the difference between an item to be focused on after a key operation is performed and an item near the item to be focused on by making the type (solid line, dotted line, etc.), thickness, and color density of borders displayed around the items shown in the “item 1 capable of being focused on” column different from those of borders displayed around the items shown in the “item 2 capable of being focused on” column and subsequent columns.

Thus, according to the second embodiment of the present invention, key colors for a focus movement are individually displayed around items. This enables a user to intuitively understand which color key the user should operate so as to move the focus to a desired item, thereby enhancing the usability of the information processing apparatus.

In the first and second embodiments, remote control keys have been used to describe the exemplary operations of the information processing apparatus. However, the embodiments of the present invention are not limited to a remote controller. Information on the input device of the input section 101 of the information processing apparatus shown in FIG. 1 may be displayed.

An embodiment of the present invention can also be achieved as follows. A storage medium storing the program code of software that achieves the functions of the above-described embodiments is provided to a system or an apparatus. The program code stored in the storage medium is read out and executed by the computer (or CPU or MPU) of the system or apparatus, whereby an embodiment of the present invention can be achieved. In this case, the program code itself read out from the storage medium achieves the functions of the above-described embodiments. Accordingly, an embodiment of the present invention can be applied to the storage medium storing the program code.

The storage medium for supplying the program code may be a flexible disk, a hard disk, an optical disc, a magneto-optical disk, a CD-ROM, a CD-R, a magnetic tape, a non-volatile memory card, or a ROM. A computer network such as a LAN (local area network) or WAN (wide area network) may be used to supply the program code.

The functions of the above-described embodiments may be achieved using other methods. An OS (operating system) or the like running on a computer may perform a part of or all of the processing in accordance with the instructions of the program code read out by the computer, whereby the functions of the above-described embodiments can be achieved.

Furthermore, the program code read out from the storage medium may be written in the memory of a feature expansion board inserted into the computer or feature expansion unit connected to the computer. Subsequently, the CPU of the feature expansion board or unit performs a part of or all of the processing in accordance with the instructions of the program code, whereby the functions of the above-described embodiments can be achieved.

In the present invention, an input section having a plurality of input units includes, for example, the remote controller 107 and input section 101 according to the first and second embodiments. The input units include, for example, the buttons or arrow keys of the remote controller 107. Correspondence information on correspondences between input units and items includes, for example, the correspondence table 501 shown in FIG. 5 in which, for example, a focused-on item (1) is associated with an input unit KEY_UP and an item ID_PULLDOWN2. Input unit information representing one of the input units includes, for example, one of images shown in the image table 601 in FIG. 6 in which input unit information upkey bmp represents an input unit KEY_UP.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2005-327569 filed Nov. 11, 2005, which is hereby incorporated by reference herein in its entirety.

What is claimed is:

1. A method comprising:
selecting one of a plurality of items displayed on a display screen based on information received via an input section that has a plurality of operable input units;
acquiring information on a correspondence between the selected item and one of the displayed items capable of being selected using one of the operable input units; and
displaying input unit information which represents the one of the operable input units along with the one of the displayed items capable of being selected using the one of the operable input units based on the acquired correspondence information.

2. A method comprising:
selecting one of a plurality of items displayed on a display screen based on information received via an input section that has a plurality of input units; and
displaying input unit information that represents one of the plurality of input units associated with one of the displayed items to be selected when the one of the plurality of input units is operated in a state corresponding to the selected item.

3. The method according to claim 1, wherein item selection is performed by focusing on one of the plurality of items.

4. The method according to claim 1, wherein item selection is performed by making a display format of one of the plurality of items different from that of the other items.

5. The method according to claim 1, wherein the input unit information corresponding to the one of the operable input units is displayed on the item capable of being selected.

6. The method according to claim 1, wherein the input unit information corresponding to the one of the operable input units is displayed by displaying a box around the item capable of being selected using the one of the operable input units.

7. The method according to claim 1, wherein the input unit information is an image or a color which represents one of the plurality of input units.

8. The method according to claim 1, wherein the input unit information corresponding to the one of the plurality of operable input units is displayed along with the item capable of being selected in accordance with a distance between the item capable of being selected using the one of the operable input units and the selected item.

9. A computer-readable medium storing instructions which, when executed by an apparatus, causes the apparatus to perform operations comprising:
selecting one of a plurality of items displayed on a display screen based on information received via an input section that has a plurality of operable input units;
acquiring information on a correspondence between the selected item and one of the displayed items capable of being selected using one of the operable input units; and
displaying input unit information which represents the one of the operable input units along with the one of the displayed items capable of being selected using the one of the operable input units based on the acquired correspondence information.

10. A computer-readable medium storing instructions which, when executed by an apparatus, causes the apparatus to perform operations comprising:
selecting one of a plurality of items displayed on a display screen based on information received via an input section that has a plurality of input units; and
displaying input unit information that represents one of the plurality of input units associated with one of the displayed items to be selected when the one of the plurality of input units is operated in a state corresponding to the selected item.

11. An apparatus comprising:
a selection unit configured to select one of a plurality of items displayed on a display screen based on information received via an input section that has a plurality of operable input units;
an acquisition unit configured to acquire information on a correspondence between the item selected by the selection unit and one of the displayed items capable of being selected using one of the operable input units; and
a display control unit configured to control the display screen to display input unit information which represents the one of the operable input units along with the one of the displayed items capable of being selected using the one of the operable input units based on the correspondence information acquired by the acquisition unit.

12. An apparatus comprising:
a selection unit configured to select one of a plurality of items displayed on a display screen based on information received via an input section that has a plurality of input units; and
a display control unit configured to control the display screen to display input unit information that represents one of the plurality of input units associated with one of the displayed items to be selected when the one of the plurality of input units is operated in a state corresponding to the item selected by the selection unit.
